(19) United States
(12) Patent Application Publication
(10) Pub. No.: US 2012/0229360 A1
(43) Pub. Date: Sep. 13, 2012

(54) INDIRECT FED ANTENNA

(75) Inventors: Ole Jagielski, Frederikshavn (DK); Simon Svendsen, Aalborg (DK)

(73) Assignee: Molex Incorporated, Lisle, IL (US)

(21) Appl. No.: 13/394,717

(22) PCT Filed: Sep. 7, 2010
(86) PCT No.: PCT/US10/47978

§ 371 Date: May 23, 2012

Related U.S. Application Data
(60) Provisional application No. 61/240,644, filed on Sep. 8, 2009.
(60) Provisional application No. 61/255,609, filed on Oct. 28, 2009.
(60) Provisional application No. 61/319,514, filed on Mar. 31, 2010.

(51) Int. Cl. H01Q 1/50; H01Q 1/38

(52) U.S. Cl. 343/860; 343/850

(57) ABSTRACT

An indirect-fed antenna system is disclosed. In an embodiment, a coupler is electrically coupled to a feed. The coupler capacitively couples to a resonating element and the resonating element is electrically coupled to a ground plane. The system allows for improved band-width and also allows for an antenna design where the resonant frequency, the bandwidth of the antenna, the location of the curl on a Smith chart and the associated impendence matching network can be separately adjusted.

This application claims priority to U.S. Provisional Application Ser. No. 61/240,644, filed on Sep. 8, 2009, to U.S. Provisional Application Ser. No. 61/255,609, filed Oct. 28, 2009 and to U.S. Provisional Application Ser. No. 61/319,514, filed Oct. Mar. 31, 2010, each of which is hereby incorporated by reference in its entirety.

### FIELD OF THE INVENTION

This invention is generally directed to antennas and antenna feed arrangements suitable for use with wireless electronic devices.

### BACKGROUND OF THE INVENTION

Modern devices suitable for receiving wireless signals have diverging requirements. One the one hand, there is constant pressure to reduce the size and cost of the device. On the other hand, there is a constant desire to improve performance. One area that has proven challenging to optimize in this regard is the antenna.

Manufactures of devices that include antennas want the antennas to work effectively in a range of environmental conditions, while being small and inexpensive to build. Many techniques have been developed to allow an antenna to have a desired resonant frequency so that the antenna can function efficiently at a desired frequency (e.g., 850 Mhz or 2.3 GHz) although size of the antenna element is still a major factor. From a performance standpoint, it is also desirable to configure an antenna so that it functions efficiently over a range of frequencies (e.g., has sufficient frequency bandwidth). Particularly for antennas that transmit signals it is beneficial to have sufficient impendence bandwidth because transmission outside an appropriate frequency range can cause increases in reflected power, which can damage the feed or transmitter. One method of addressing the impedance bandwidth of an antenna is to use a increased distance to ground. However, the volume of space available for the antenna is often limited. Consequentially, often a compromise in antenna design is required due to existing technology for improving the impendence bandwidth of an antenna. Thus, further improvements in antenna design would be appreciated.

### SUMMARY OF THE INVENTION

An embodiment of an antenna system includes a resonant element that is electrically coupled to a ground plane. The resonant element is also configured to be capacitively coupled to a coupler, and the coupler is electrically coupled to a feed which is configured to be electrically coupled to a transmitter (which may be a transceiver). Thus, the resonant element is indirectly coupled to the feed. When the coupler receives a signal from the transmitter via the feed, the capacitive coupling between the coupler element and the resonant element, in combination with the capacitive coupling between the coupler and the ground plane, helps provides an antenna system with improved bandwidth versus a system that used a comparably sized resonating element and a direct feed.

### BRIEF DESCRIPTION OF THE DRAWINGS

The organization and manner of the structure and operation of the invention, together with further objects and advantages thereof, may best be understood by reference to the following description, taken in connection with the accompanying drawings, wherein like reference numerals identify like elements in which:

FIG. 1 is a perspective view of an embodiment of a high impedance indirect fed slot antenna;

FIG. 2 is a circuit representative of the antenna embodiment depicted in FIG. 1;

FIG. 3A is a Smith chart illustrating impedance characteristics of the antenna of FIG. 1 prior to impedance matching;

FIG. 3B is a Smith chart illustrating impedance characteristics of the antenna of FIG. 1 after impedance matching;

FIG. 4 is a Smith chart illustrating impedance characteristics of a direct fed antenna;

FIG. 5A is a perspective view of an embodiment of a low impedance indirect fed slot antenna;

FIG. 5B is a perspective view of an alternate embodiment of a low impedance indirect fed slot antenna;

FIG. 6A is a circuit representative of the antenna depicted in FIG. 5A

FIG. 6B is a circuit representative of the antenna depicted in FIG. 5B;

FIG. 7A is a Smith chart illustrating impedance characteristics of the antenna of FIG. 5A prior to impedance matching;

FIG. 7B is a Smith chart illustrating impedance characteristics of the antenna of FIG. 5A after impedance matching;

FIG. 8 is a Smith chart illustrating impedance characteristics of a direct fed antenna;

FIG. 9 is a perspective view of an alternate embodiment of a low impedance indirect fed slot antenna;

FIG. 10 is a perspective view of an alternate embodiment of a low impedance indirect fed slot antenna;

FIG. 11 is a perspective view of an alternate embodiment of a low impedance indirect fed slot antenna;

FIG. 12 is a perspective view of an alternate embodiment of a low impedance indirect fed slot antenna;

FIG. 13 is a perspective view of an alternate embodiment of a low impedance indirect fed slot antenna;

FIG. 14A is a perspective view of an alternate embodiment of a low impedance indirect fed slot antenna;

FIG. 14B is a cross-sectional view of the low impedance indirect fed slot antenna of FIG. 14A;

FIG. 15 is a perspective view of an embodiment of an antenna including a low impedance slot fed antenna and a high impedance slot fed antenna providing a parasitic resonant element;

FIG. 16 is a circuit representative of the impedance matching networks of the antenna embodiment depicted in FIG. 15;

FIG. 17A is a Smith chart illustrating the antenna impedance of the antenna of FIG. 15 at a low frequency range;

FIG. 17B is a Smith chart illustrating the antenna impedance of the antenna of FIG. 15 at a high frequency range; and

FIG. 18 is a plot depicting isolation of the frequency ranges of the antenna of FIG. 15.

### DETAILED DESCRIPTION OF THE ILLUSTRATED EMBODIMENT

The detailed description that follows describes exemplary embodiments and is not intended to be limited to the expressly disclosed combination(s). Therefore, unless otherwise noted, features disclosed herein may be combined together to form additional combinations that were not otherwise shown for purposes of brevity.

The depicted embodiments provide a new antenna which provide improved impedance bandwidth for a given antenna volume. High impedance slot fed antennas (HISFA) and low impedance slot fed antenna (LISFA) allow for new techniques for feeding the antennas. Due to the limited space available for antennas in portable communications devices, the antennas are useful in portable communications devices. These HISFA and LISFA also have the ability to allow various characteristics of the antenna system to be adjusted individually, which can provide a substantial improvement to the development cycle because adjusting one aspect of the system need not have a substantive affect on another system characteristic.

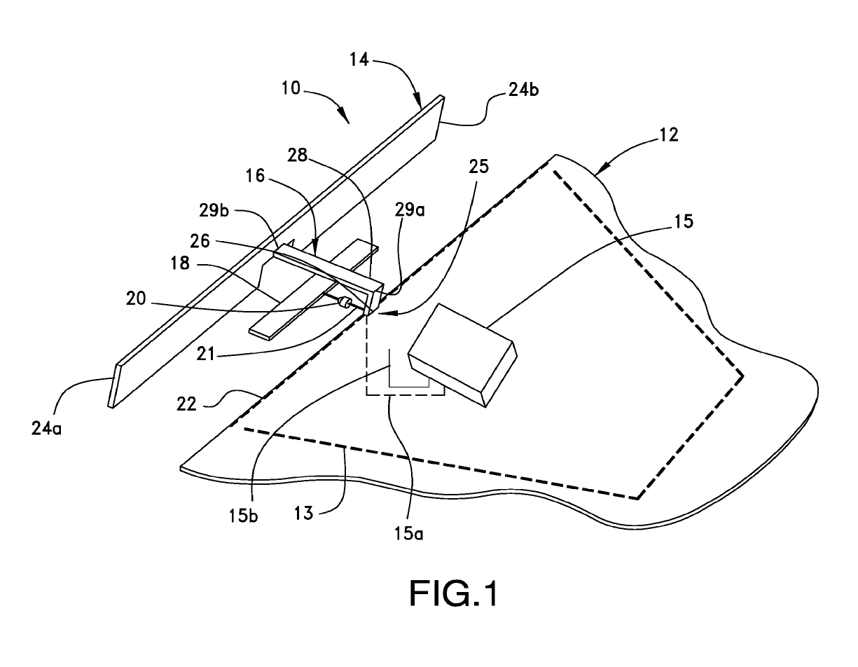

A first embodiment is shown in FIG. 1 and is a high impedance slot fed antenna (HISFA) 10. The HISFA is provided in connection with a circuit board 12 which provides a ground plane 13 and a transceiver 15. The HISFA 10 includes a resonant element 14 connected to the ground plane 13 through a ground arm 16 and a coupler 18 spaced from both the circuit board 12 and the resonant element 14. A feed 20 is electrically connected to the transceiver 15 via transmission line 15a and the feed 20 may include a circuit element 21 (which may be one or more elements that allow for better impedance matching between the transceiver 15 and the antenna 10) and the feed 20 provides the input that allows the antenna 10 to transmit signals.

A portion of the circuit board 12 is shown in FIG. 1. The dimensions of the circuit board 12 and the location and configuration of the ground plane 13 (which is shown in phantom line) and transceiver 15 (which can be coupled to the ground plane 13 via transmission line 15b) can vary in accordance with the design parameters of the particular device. Often a transceiver will be a module mounted on the circuit board 12 that provides integrated transmission and reception capabilities. However, while a typical transceiver integrates the receiving and transmitting functionality, it should be noted that the term transceiver as used herein is intended to be more broadly directed toward a functional module that can provide both the reception and transmission capabilities, regardless of whether it is a component that directly integrates transmit and receive components. Furthermore, the transceiver will have a transmission path coupled to the feed and a second transmission path coupled to the ground plane.

The ground plane 13 is typically provided in one or more layers of the circuit board 12 and while shown in a dotted line as a discrete area for purposes of illustration, often extends substantially across the entire circuit board while providing various voids that allow signal traces to extend through the ground plane. For example, in the depicted embodiment it is expected that the ground plane 13 would be provided along a majority of the circuit board 12 near the area where the resonant element 14 is located and can extend to an edge of the circuit board. The use of a ground plane in a circuit board is known in the art and therefore further discussion of the full shape and size of a particular ground plane design will be omitted for purposes of brevity, it being recognized that different ground plane configurations may be used as appropriate for the particular circuit board design. The ground plane 13 includes an edge 22, which in an embodiment can extend some length defined by the distance between opposite ends 24a, 24b.

The resonant element 14 is connected to the circuit board 12 through the ground arm 16, which is coupled to a ground plane 13 of the circuit board 12. The depicted resonant element 14 is planar, rectangularly-shaped and includes opposite free ends 24a, 24b. The length of the resonant element 14 is defined by the distance between the ends 24a, 24b. The resonant element 14 is spaced from the edge 22 of the ground plane 13. In addition, the resonant element 14 is positioned above the plane in which the circuit board 12 is positioned. In an embodiment, the resonant element 14 can be spaced approximately 3 mm from the edge 22 of the circuit board 12 and be positioned approximately 5 mm above the circuit board 22. The resonant element 14 can be formed of any desirable conductive material suitable for use as a resonant element.

The depicted ground arm 16 is L-shaped and preferably is kept short to minimize inductance and includes a first portion 26 and a second portion 28, although the ground arm 16 can be other shapes as desired (such as a spring or pogo clip). The first portion 26 of the ground arm 16 extends from the circuit board 12 and is generally perpendicular to the circuit board 12. The second portion 28 includes opposite first and second ends 29a, 29b. The first end 29a of the second portion 28 is attached to the upper end of the first portion 26. The second portion 28 generally extends perpendicularly from the first portion 26. The resonant element 14 is attached to the second portion 28 of the ground arm 16 at the second end 29b thereof. The ground arm 16 can also be formed of a desirable conductive material, which may be similar or different than that used for the resonant element 14. To provide more control over the performance of the resonant element, an inductor 25 can be positioned in series with the resonant element 14 and in an embodiment can be positioned between the ground arm 16 and the ground plane 13.

The depicted coupler 18 has rectangular, planar shape and fits well between the antenna and the ground plane, although other shapes can also be used. The coupler 18 is depicted between the edge 22 of the ground plane 13 and the resonant element 14 and is spaced from the edge 22. However, the coupler 18 need not be positioned between the ground plane 13 and the resonant element 14 but instead can be positioned so that the desired coupling between the ground plane and the resonant element occurs. The coupler 18 can also be of any desirable conductive material. As will be discussed below, the coupler 18 has a length and the length can be adjusted as desired.

The feed 20 is in electrical communication with the transceiver 15 via transmission line 15a and generally extends from circuit board 12 to the coupler 18. The feed 20 can be formed from any suitable conductive element and in an embodiment can have an impedance of approximately 50 Ohms.

Unlike prior art antennas which typically provide for a direct feed connection wherein the feed is directly connected to the resonant element, the resonant element 14 depicted in FIG. 1 is indirectly fed. More specifically, a direct connection is not provided between the feed 20 and the resonant element 14 when signals are being transmitted wirelessly via the antenna 10 to a remote location. Rather, the feed 20 receives signals from the transceiver 15 (via transmission line 15a) and provides the signals to the coupler 18. The coupler 18 is capacitively coupled to the resonant element 14 and this allows the energy transmitted to the coupler to be provided to the resonant element (which is in turn configured to radiate the signal as is conventional for antennas). The performance of the resonant element 14 is also affected by capacitive coupling between the ground plane 13 and both the coupler and the resonant element. Likewise, when signals are being received by antenna 10, signals received by the resonant element 14 are passed to the transceiver 15 via the coupler 18 through electromagnetic or capacitive coupling and the connection to the ground plane 13 provided by the ground arm 16. The overall performance of the antenna 10 can be adjusted by varying the value of elements 21, 25 (the possible location of which is shown in FIG. 1) positioned in the path, as well as the spacing and orientation of the elements of the antenna that are capacitively coupled together. In other words, the spacing between the coupler 18 and the resonant element 14, as well as the spacing between edge 22 and coupler 18 and the spacing between the edge 22 and the resonant element 14 affect the performance of the antenna 10. In addition, the size of the coupler 18 would also affect the performance of a particular antenna configuration. Naturally, if the edge 22 did not extend the entire length of the resonant element that would also affect the capacitive coupling therebetween. More will be said about this below.

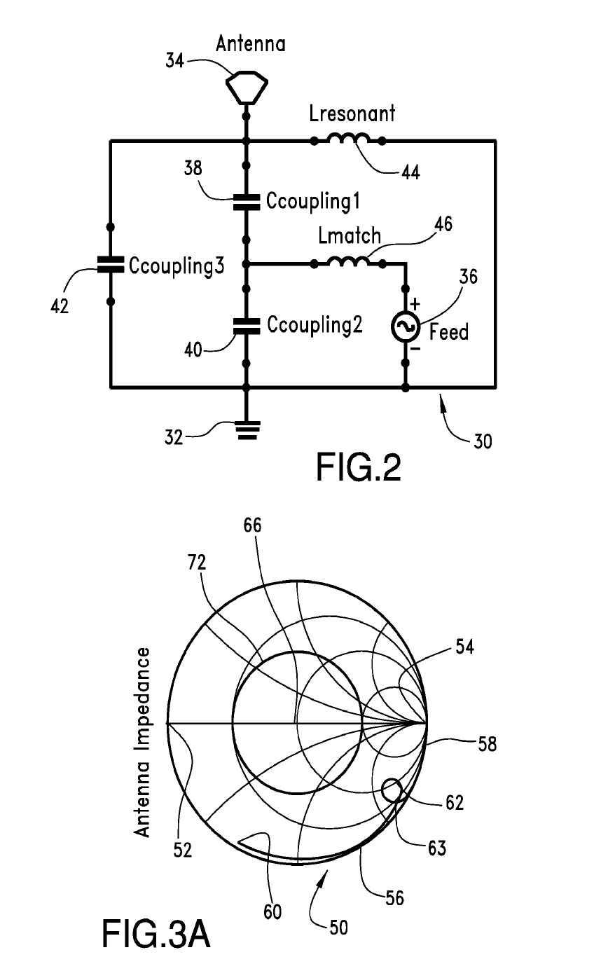

A circuit 30 that is equivalent to the HISFA of FIG. 1 is shown in FIG. 2. The circuit 30 includes a ground plane 32 that is equivalent to the ground plane 13 of the circuit board 12; a resonant element 34 equivalent to the resonant element 14; and a feed 36 equivalent to the feed 20 of FIG. 1. In addition, the equivalent circuit 30 of FIG. 2 also includes C_{coupling1} 38, C_{coupling2} 40, C_{coupling3} 42, Lᵣₑₛₒₙₐₙₜ 44, and L_{match} 46.

C_{coupling1} 38, C_{coupling2}40, and C_{coupling3} 42 represent capacitive coupling which exists in the HISFA of FIG. 1. Coupling capacitor, C_{coupling1} 38, represents capacitive coupling between the resonant element 14 and the coupler 18. Coupling capacitor, C_{coupling2} 40, represents capacitive coupling between the coupler 18 and the ground plane 13. Coupling capacitor, C_{coupling3} 42, represents capacitive coupling between the ground plane 13 and the resonant element 14. The relationship between C_{coupling1} 38, C_{coupling2} 40 and C_{coupling3} 42 is used to adjust the width frequency range of the resonance so as to (for the particular application) optimize performance of the antenna 10.

Resonant inductance, Lᵣₑₛₒₙₐₙₜ 44, represents the inductance between the ground arm 16 supporting the resonant element 14 and the ground plane 13 of the circuit board 12. This inductance, which can be provided by the element 25 in FIG. 1, provides a discrete inductance having a value which is selected and used to force the resonant element 34, 14 into resonance at a particular frequency as will be described herein.

More specifically, the size of the resonant element relates to its frequency response. For applications where it is undesirable (either for space or cost reasons) to increase the size of the resonant element sufficiently to provide the desired frequency response, an inductor can be positioned in series between the resonant element and the ground plane so as to electrically increase the length of the resonant element with a resonant inductance (e.g., Lᵣₑₛₒₙₐₙₜ 44). As can be appreciated, when viewed on a Smith chart, this tends to shift the location of the curl toward lower frequencies (e.g., to the right on the plot).

Next, as noted above, the length of the capacitive coupler can be adjusted. Increasing the length of the capacitive coupler 18 causes the location of the plot of the frequency response of the resonant element (which will be discussed below) to shift clockwise. Thus, by varying the length of the coupler 18 it is possible to vary the location of the entire plot (and thus the curl) in the Smith chart. As changing only the length of the coupler does not tend to affect the coupling ratio of the capacitive coupling between the coupler and of the resonant element and capacitive coupling between the coupler and the ground plane, this allows the location of the curl to be adjusted separately. As a person of skill in the art can appreciate, the resultant location of the curl in the Smith chart will allow the use of different components (and values) to ensure the impedance of the antenna system matches the impedance of the transceiver (typically about 50 Ohms but any desirable value can be aimed for) so that SWR is at a desirable level for the frequencies of interest.

To adjust match the impedance of the antenna system with the transceiver, a matching component, L_{match} 46, which can be provided by element 21, provides the appropriate value between the feed 36 and the transceiver 15. In an embodiment, the matching component, L_{match} 46 can be a discrete impedance which is selected and positioned in series with the feed 20 to match the impedance of the coupler 18 with the feed impedance 20. In FIG. 2, the impedance matching component 46 has been illustrated as an inductor in series due to the location of the curl in the Smith chart. It is to be understood, however, that alternatively the impedance matching component 46 could also be a capacitor C_{match}.in series if the location of the curl was in the upper right portion of the Smith chart. Alternatively still, the impedance matching component could be a parallel inductor or capacitor if the curl was located on the lower left or upper left portion of the Smith chart, respectively.

The HISFA 10 can be utilized in connection with a variety of communications standards. For example, in an embodiment the HISFA can be utilized to provide coverage of the GSM 850 and the GSM 900 standards with a return loss of not more than about −6 dB. However, it should be noted that the HISFA could be used for a variety of frequency ranges, as desired.

As is known, the GSM 850 standard utilizes frequencies between 824 and 849 MHz to send information and utilizes frequencies between 869 and 894 MHz to receive information. The GSM 900 standard utilizes frequencies between 890 and 915 MHz to send information and utilizes frequencies between 935 and 960 MHz to receive information. When utilizing GSM 850 and GSM 900 standards, therefore, the HISFA performance can be optimized when the center of the resonant element frequency response is about 890 MHz. In order to provide resonance of the resonant element 14 at about 890 MHz, the frequency response of the antenna 10 can be tuned through the use of inductor and by placing a discrete inductor in series between the ground arm 16 and the ground plane 13, for example, this can adjust the resonant inductance 44 which will cause the resonant element 14 to resonate at the desired frequency of 890 MHz. As can be appreciated, the value of the inductor used (if desired) will vary depending on the desired shift in frequency response in the resonating element.

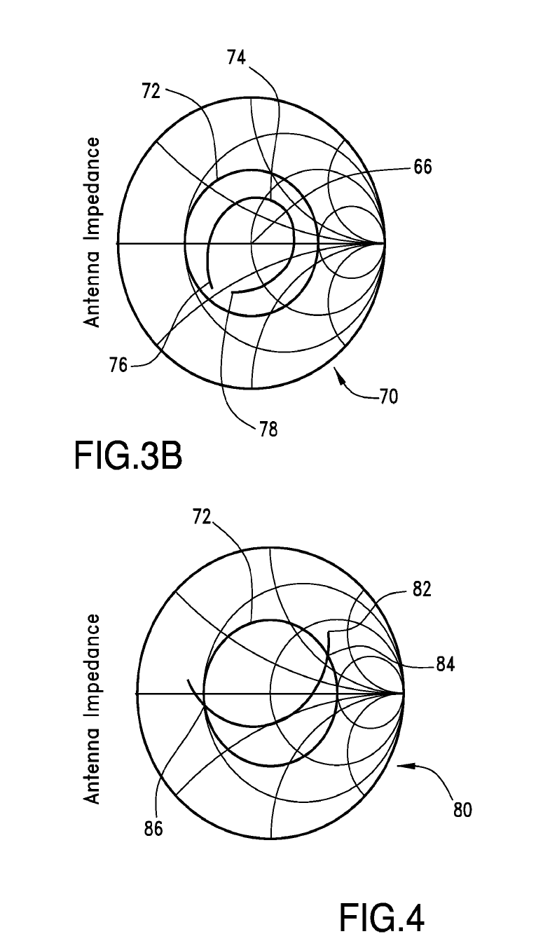

The Smith chart 50 of FIG. 3A provides a plot 56 of the impedance of an embodiment of the antenna 10 depicted in FIG. 1 at various frequencies. As is conventional, the Smith chart 50 provides a left reference point 52 representing an antenna impedance of zero and a right reference point 54 representing an impedance of infinity. The plot 56 includes a first or beginning point 58 and a second or ending point 60. Points in the top half of the chart 50 represent impedances with a positive imaginary component and points in the bottom half of the chart 50 represent impedances with a negative imaginary component. The first point 58 provides an indication of the impedance of the antenna at a frequency of approximately 500 MHz. The second point 60 provides an indication of the impedance of the antenna 10 at a frequency of approximately 3 GHz. In general, as the frequency is increased, the impedance of the antenna moves clockwise from the point of high impedance to a point of lower impedance. The plot 56 includes a curl 62. The curl 62 provides an intersection point 63 at which the impedance plot 56 intersects with itself. The points along the curl 62 represent the frequencies at which the resonant element 14 is in resonance (e.g., the frequency bandwidth of the antenna).

As noted above, the frequency at which the resonant element 14 is intended to resonate is determined by the intended use of the antenna. Thus, if the resonant element 14 is not resonating at a sufficiently low frequency, the resonant frequency of the resonant element 14 can shifted lower by adding an inductor (as discussed above), which shifts the curl 62 counter clockwise along the plot illustrated in the Smith chart. This allows the designer of the system to avoid having to increase the size of the resonant element 14.

In the depicted embodiment, the resonant frequency of the resonant element 14 is shifted by applying the resonant inductance, Lᵣₑₛₒₙₐₙₜ 44, between the ground plane 13, 32 and the resonant element 14, 34. When, for example, the inductor 25/inductor Lᵣₑₛₒₙₐₙₜ 44 is placed between the ground plane 13, 32 and the resonant element 14, 34 the frequency at which the element 14, 34 resonates is decreased (e.g., the location at which the curl 62 is positioned within the plot on the Smith chart is altered). If for example, the desired resonant frequency is 890 MHz and the size of the resonant element 14 is too small to resonate at the 890 MHz, the resonant element 14 can be forced into resonance at 890 MHz by applying the inductor 25 between the ground plane 13 and the ground arm 16 of the resonant element 14. Fine tuning of the resonant frequency of the element to the desired resonant frequency can be accomplished by increasing or decreasing the value of Lᵣₑₛₒₙₐₙₜ 44. If for example, the designer wants the resonant element 14 to resonate at a lower frequency, the designer can increase the value of Lᵣₑₛₒₙₐₙₜ 44. On the other hand, if the designer desires to have the resonant element 14 resonate at a higher frequency, the designer can decrease the value of Lᵣₑₛₒₙₐₙₜ 44. In addition to tuning the antenna 10 to provide resonance at the desired frequency, the performance of the antenna 10 can also be optimized by increasing the bandwidth of the antenna, as is discussed below.

Once the curl is the desired size, the system can be further optimized so as to match the impedance of the coupler 18 to the impedance of the transceiver. Tuning through this impedance matching is illustrated by the plot 74 of the antenna impedance provided in the Smith chart 70 of FIG. 3B. When no impedance mismatch exists, no power is reflected and the antenna provides a standing wave ratio of 1.0. When an impedance mismatch exists, power is reflected and the standing wave ratio increases. Typically, the desired impedance of the feed 20 is 50 Ohms. Therefore, to help reduce an impedance mismatch, Lmatch 46 (which can be an inductor and is represented by element 21 in FIG. 1) can be positioned in series before the coupler so as to reduce the impedance mismatch between the transceiver and the coupler 18. Standing wave ratios are illustrated in the Smith chart by circles having a center point at the prime center point 66. A standing wave ratio of 1.0 is represented by the prime center point 66 itself, e.g., a circle with a radius equal to zero. At this center point 66, the impedance of the feed 20 is perfectly matched with the impedance of the coupler 18, e.g., no reflected power is provided. In any given antenna, some mismatch in impedance will be present, however, the goal is to match the impedances of the antenna to the feed as closely as possible, bringing the plot of antenna impedance 66 as close to the prime center point 66 as possible. Typically, a standing wave ratio of 3.0 or lower is considered to provide an acceptable range of reflection. Thus, the SWR of 3 circle 72 is illustrated in the Smith charts 50, 70 of FIGS. 3A and 3B and represents antennas having a SWR of 3. The bandwidth of the antenna 10, therefore, can be determined by observing the portions of the plot 74 which fall within the SWR of 3 circle 72 and determining the frequencies associated with that portion of the plot 72.

As previously noted, FIG. 3A illustrates the impedance of antenna 10 prior to impedance matching. As shown in FIG. 3A, the antenna impedance of the indirect fed antenna 10 starts at the high impedance region of the Smith chart 50, e.g., proximate the high impedance reference point 54. As can be appreciated from the embodiment depicted in FIG. 3A when impedance matching is not provided, the plot 56 may not fall within the SWR of 3 circle 72. FIG. 3B illustrates the indirect fed, HISFA impedance matched to 50Ω by using L_{match}. The portion of the plot 74 of the antenna impedance illustrated in FIG. 3B begins with a first point 76 and ends with a second point 78. The illustrated portion of the plot 74 essentially only includes the curl portion of the antenna impedance plot. Thus, with the use of impedance matching, the curl of the plot 74 falls within the SWR of 3 circle as desired. In an embodiment, the first point 76 of plot 74 corresponds to a frequency of 820 MHz and the second point 78 corresponds to a frequency of 960 MHz, indicated that the bandwidth of the impedance matched antenna 10 includes frequencies from about 820 MHz to 960 MHz.

It should be noted that sometimes simply shifting the curl toward the center of the Smith chart may not be sufficient because the bandwidth of the resonant element is insufficient. Or to put it another way, the range of frequencies covered by the curl is too small. It has been determined that one way to increase this range of frequencies is to vary the ratio of capacitive coupling between the coupler and the resonating element and the capacitive coupling between the coupler and the ground plane. Increasing this ratio will increase the frequency range of the curl (e.g., increase the size of the curl). It has been determined that there typically is a limit to the benefit of increasing the size of the curl because it is still desirable to have the curl to fit within the SWR circle of 3, thus a curl larger than the SWR circle of 3 may actually reduce the available bandwidth of the antenna system. Therefore, it may be beneficial to increase the size of the curl to some size by adjusting the capacitive coupling ratio and then moving the location of the curl toward the center with the appropriate matching network.

As a comparison, the Smith chart 80 of FIG. 4 includes an impedance plot 82 which illustrates the impedance properties of an antenna system with the same resonating element 14 used to generate the plots in FIGS. 3A and 3B but with a standard direct feed. Unlike FIG. 3B in which the entire curl of the impedance plot 74 falls within the SWR of 3 circle 72, in FIG. 4 only a portion of a curl of the impedance plot 82 falls within the SWR of 3 circle 72. More specifically, the impedance plot 82 includes a first point 84 which intersects the SWR of 3 circle 72 and a second point 86 which intersects the SWR of 3 circle 72. The first point of intersection 84 corresponds to a frequency of 831 MHz and the second point of intersection 86 corresponds to a frequency of 920 MHz. Thus, the bandwidth of a comparable direct fed antenna, as illustrated in FIG. 4, is about 831 MHz to 920 MHz because attempting to use the antenna at frequencies outside this range would tend to have an undesirable SWR ration that could damage the transceiver.

Table 1 below provides a comparison of the bandwidth provided by using the standard direct fed method and the indirectly fed method of the HISFA 10 depicted in FIG. 1. As illustrated in Table 1, the standard direct fed antenna has a bandwidth of 89 MHz. In contrast, the bandwidth of the indirect fed HISFA 10 is 170 MHz. The impedance characteristics of the HISFA are very similar to that of a Chebychev match.

TABLE 1
Impedance bandwidth of Standard Direct Feed and
High Impedance Slot Feed

| | | Bandwidth Frequencies at SWR = 3 | | |
|---|---|---|---|---|
| | Start | Stop | Bandwidth | Bandwidth |
| Standard Direct Feed | 831 MHz | 920 MHz | 89 MHz | 10.2% |
| High Impedance | 820 MHz | 990 MHz | 170 MHz | 8% |
| Slot Feed | | | | |
| mprovement | | | 81 MHz | 84.3% |

As can be observed from TABLE 1, when the new indirect feed technique of the antenna of FIG. 1 is utilized, a bandwidth of 170 MHz is achieved (which is a 91 percent increase from a frequency standpoint). Preferably the use of the indirect fed method will provide at least 130% of the frequency response of a direct fed antenna (e.g., at least 105 MHz) and more preferably can provide more than 160% of frequency response of a direct fed antenna (e.g., at least 130 MHz). In addition, the bandwidth provided by the appropriate configuration of the HISFA 10 is sufficient to cover both GSM850 and GSM900. Thus, for a given resonant element 14 (e.g., for a given volume), substantially greater bandwidth is possible using the indirect feed technique. It should be noted that the depicted shape of the resonating element 14 in FIG. 1 is one of a number of possible shapes and the shape is not intended to be limiting unless otherwise noted.

As can be appreciated, the features of FIG. 1 are not limited to being configured for a particular frequency but instead are generally applicable to a range of frequencies. One of the benefits of the depicted design is that the frequency response of the resonant element, the location of the curl, the size of the curl, and the configuration of the matching network that allows the antenna impedance to be matched with the transceiver can all be adjusted separately. This provides substantial benefits for a system designer because, unlike convention systems, it is possible to adjust one of these characteristics without change a number of other characteristics (at least the other characteristics need not be changed substantially).

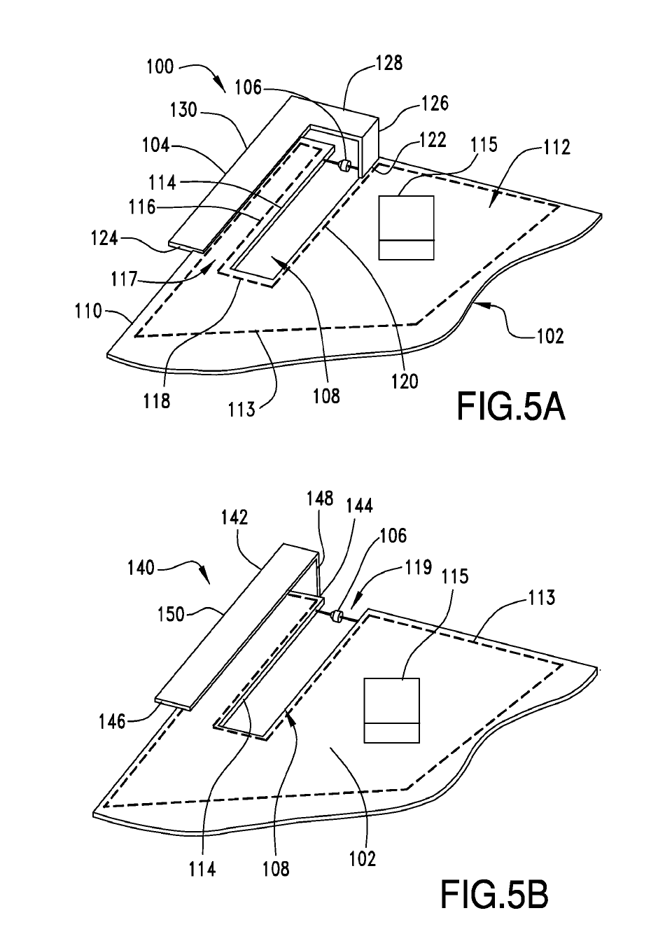

Second and third embodiments are illustrated in FIGS. 5A and 5B respectively. FIG. 5A illustrates an embodiment of a low impedance slot fed antenna (LISFA) 100 and FIG. 5B illustrates another embodiment of a low impedance slot feed antenna (LISFA) 140. Similar to the HISFA 10 of FIG. 1, the antennas 100, 140 of FIGS. 5A and 5B are also indirectly fed. The depicted LISFA antenna is configured to provide a high-band antenna and one possible goal of a high-band antenna is to cover GSM 1800, GSM 1900 and UMTS band I at a return loss at −6 dB. However, it should be noted that the LISFA could also be configured to function at any desired frequency (e.g., it could work for the low band or some other desired frequency, as desired).

The LISFA 100 of FIG. 5A and the LISFA 140 of FIG. 5B each are provided in connection with a circuit board 102, which can be substantially the same in both embodiments. The circuit board 102 includes a ground plane 113 and supports a transceiver 115. The location and configuration of the ground plane 113 and the transceiver 115 will vary in accordance with the design parameters of the particular device (as discussed above with respect to FIG. 1).

The circuit board 102 is generally planar and is partially depicted in FIG. 5A and FIG. 5B. The dimensions of the circuit board 102 can vary in accordance with the design parameters of the particular device. A slot 108 is provided in the circuit board 102 spaced from an edge 110 of the circuit board 102 and the slot 108 helps define a finger 117 with an edge portion 114 that forms a side of the of the slot 108. The ground plane 113 extends along the finger 117 and includes a first edge 116 that extends along the edge portion 114 of the circuit board 102, a second edge 120 in the ground plane 113 is supported by the main portion 112 of the circuit board 102, and an end edge 118 extends between the first edge 116 and the second edge 120. It should be noted, however, that while the depicted embodiment has a slot 108 in the circuit board 102, in an embodiment only the ground plane 113 will have the void that defines a slot similar that that depicted. The open portion of the slot 108 thus requires that signals provided through a feed 106 to a first side of the slot 108 pass along the distance defined by edges 116, 118 before returning to the transceiver 115 (which is on the second side of the slot 108). The dimensions of the slot 108 (which as noted, in certain embodiments may only be in the ground plane) can be, for example, approximately 1 mm in width by 12 mm in length. In an embodiment, the slot 108 can be positioned approximately 1 mm from the edge 110 of the circuit board 102 so that finger 117 has a width that is approximately 1 mm and a length of approximately 12 mm. However, these dimensions can be adjusted as noted below to provide the desired system performance for a particular resonating element configuration.

The LISFA 100 includes a resonant element 104 connected to the ground plane 113 of the circuit board 102 on the second side of the slot 108. As depicted, the resonant element 104 includes a fixed end 122 electrically coupled to the ground plane 113 and a free end 124, which is on the first side of the slot 108. The resonant element 104 also generally includes a support portion 126, an extension portion 128, and a body portion 130. A feed 106 is coupled to the transceiver 115 of the circuit board 102 (with transmission lines such as those depicted in FIG. 1 but not shown here for purposes of clarity) and extends to the first side of the slot 108. Thus, signals from the transceiver pass through the feed and around the slot back to the transceiver. The ground plane 113 is magnetically coupled to the resonant element 104 but is electrically isolated from the ground plane 113 at the free end 124. This separation causes the induced current to have flow in the opposite direction of the current generated by the finger, thus increasing the impedance of the resonant element 104. As noted above, an inductor can be positioned in series between a resonant element and a ground plane to adjust the frequency response of the resonant element. It should be noted that while the resonant element is depicted as being rectangular, any desirable shape could be used. In addition, while the resonant element and ground plane are shown as being substantially parallel, the resonant element and the ground plane need not be configured in a parallel manner.

The support portion 126 of the resonant element 104 is attached to the ground plane 113 and as depicted, the support portion 126 is coupled to the ground plane 113 proximate the slot 108. The extension portion 128 of the resonant element 104 extends from the support portion 126 to the body portion 130. As illustrated in FIG. 5A, the extension portion 128 of the LISFA 100 extends across the slot 108. The body portion 130 of the resonant element 104 extends from the extension portion 128 and is generally positioned over and parallel to the finger 117. As depicted, the support 126, extension 128 and body 130 portions of the resonant element 104 are integrally formed. While the spacing can be adjusted as desired, in an embodiment the support portion 126 of the resonant element 104 can be configured so at to provide a gap between the finger 117 and the body 130 that is approximately 5 mm. It should be noted, however, that exact alignment between the body 130 and the finger 117 is not required, instead the value of capacitive coupling between the body 130 and the ground plane 113 provided in the finger is what is used to adjust the performance of the antenna system.

The feed 106 is coupled to the transceiver 115 and extends across the slot 108 of the circuit board 102 proximate the open end 119 of the slot 108. The feed 106 extends from the main portion 112 of the circuit board 102 to the first edge 116 of the ground plane 113. The feed 106 can be provided by a coaxial cable, for example. The slot 108 is fed by the feed 106. Because the finger 117 and the body 130 are capacitively coupled, an output which travels from the transceiver 115 through the feed 106 across the slot, along the finger 117 and back to the transceiver (thus causing the current path to go in a first direction along one edge of the slot and a second direction on the opposite edge of the slot) causes the resonant element 104 to radiate electromagnetic waves (and act as an antenna). Changing the distance between the finger 117 and the body 130 (as well as the width of finger and/or body) can affect the frequency response of the resonant element 104. In addition, changing the dimensions of the slot can also modify the frequency response of the resonant element 104.

For example, increasing the length of the slot functions similarly to increasing the length of the coupler 18 depicted in FIG. 1 and allows the location of the plot in the Smith chart (as well as the curl) to be adjusted. Increasing the ratio of the value of capacitive coupling between the finger 117 and the body of resonant element 104 over the value of the capacitive coupling across the slot 108 increases the size of the curl. In addition, the location of the curl can be shifted toward the center of the Smith chart with the appropriate matching network and the frequency response of the resonant element can be adjusted by varying the electrical length with the addition of an inductor. Thus, the antenna system depicted in FIG. 5A can have the various characteristics adjusted individually, just like the antenna system depicted in FIG. 1.

It should be noted that while both systems function similarly, the system in FIG. 5A uses a slot in the ground plane instead of a coupler. For certain configurations, the desired length of the slot may make it difficult to package the antenna system and therefore using a separate coupler may be preferable. The advantage of using the slot, however, is a coupler is not needed.

Turning to the embodiment depicted in FIG. 5B, the LISFA 140 includes a resonant element 142 electrically connected to the ground plane 113 at a fixed end 144, which is attached to the ground plane 113 of the circuit board 102 and a free end 146. The resonant element 142 of the LISFA 140 of FIG. 5B includes a support portion 148 and a body portion 150 but does not include an extension portion. As depicted, the support portion 148 of the resonant element 142 is electrically coupled to the ground plane 113 at a first end 144 and the supports the body 150 in the desired position. The body portion 150 of the resonant element 142 of FIG. 5B extends from the support portion 148 and is configured to capacitive couple to the ground plane 113 provided in the finger 117. In an embodiment, the support portion 148 of the resonant element 142 has a length of approximately 5 mm to provide a gap of 5 mm between the body portion 150 of the resonant element 142 and the ground plane 113 provided in the finger 117, although the desired distance will vary from system to system and antenna to antenna, depending on the requirements of the system.

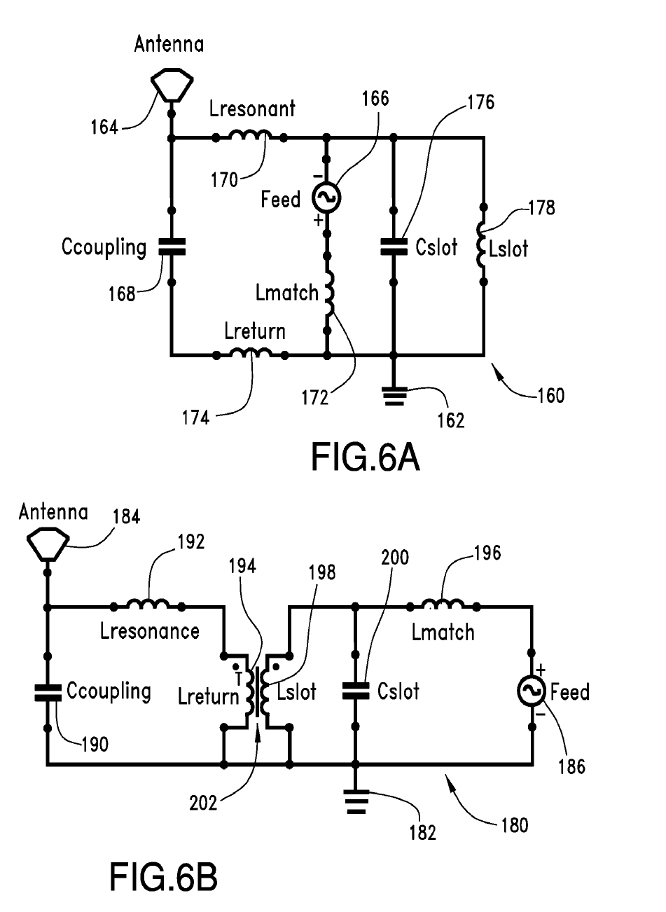

A circuit 160 representative of the antenna embodiment 100 of the LISFA of FIG. 5A is illustrated in FIG. 6A. The circuit 160 includes a ground plane 162 representative of the ground plane 113 of the circuit board 102; a resonant element 164 representative of the resonant element 104; and a feed 166 representative of the feed 106. The representative circuit 160 also includes the elements C_{coupling} 168, Lᵣₑₛₒₙₐₙₜ 170, L_{match} 172, Lᵣₑₜᵤᵣₙ 174, Cₛₗₒₜ 176 and Lₛₗₒₜ 178.

C_{coupling} 168 represents capacitive coupling which exists in the LISFA 100 between the resonant element 104, 164 and the ground plane 113, 162. Resonant inductance, Lᵣₑₛₒₙₐₙₜ 170, provides impedance between the ground plane 113, 162 and the resonant element 104, 164. Although not illustrated in FIG. 5A, the resonant inductance 170 can be one or more discrete elements which can be selected and used to force the resonant element 104 into resonance at a desired frequency.

Impedance matching component, L_{match} 172, provides impedance in series with the transceiver 115 and the feed 106, 166. Although not illustrated in FIG. 5A, the matching impedance, L_{match} 172, can be a discrete element or elements which is used to match the impedance of the feed 106 to the impedance of the transceiver 115. In FIG. 6A, for example, the impedance matching component 172 has been illustrated as an inductor. It is to be understood, however, that as noted above, that the impedance matching component 172 can be configured as desired, depending on the location of the curl in the Smith chart.

A current return path is provided by the resonant element 104. The inductance in the current return path of the resonant element 104 is illustrated by the inductor Lᵣₑₜᵤᵣₙ 174. The impedance of the slot 108 is illustrated by Cₛₗₒₜ 176 and Lₛₗₒₜ 178.

A circuit 180 representative of the LISFA 140 of FIG. 5B is illustrated in FIG. 6B. The circuit includes a ground plane 182 equivalent to the ground plane 113 of the circuit board 102; a resonant element 184 equivalent to the resonant element 142; and a feed 186 equivalent to the feed 106. The circuit 180 also includes the elements C_{coupling} 190, Lᵣₑₛₒₙₐₙₜ 192, Lᵣₑₜᵤᵣₙ 194, L_{match} 196, Lₛₗₒₜ 198 and Cₛₗₒₜ 200.

C_{coupling} 190 represents capacitive coupling which exists in the LISFA 140 between the resonant element 142 and the ground plane 113, 182. Resonant inductance, Lᵣₑₛₒₙₐₙₜ 192, provides inductance between the circuit board 102 and the resonant element 142, 184 so as to increase the electrical length of the resonant element, as discussed above.

A current return path is provided by the resonant element 142, 184. The inductance in the current return path of the resonant element 142 is illustrated by inductor Lᵣₑₜᵤᵣₙ 194. The impedance of the slot 106 is illustrated by Cₛₗₒₜ 200 and Lₛₗₒₜ 198. The transformer 202 of the equivalent circuit 180 illustrates the mutual coupling between Lᵣₑₜᵤᵣₙ 194 and Lₛₗₒₜ 198.

Impedance matching component, L_{match} 196, provides impedance in series with the feed 106, 186 and the resonant element 142, 184. Although not illustrated in FIG. 5B, the impedance matching component, L_{match} 196 can be a discrete element (as discussed above) which is selected based on the position of the curl in the Smith chart so as to match the impedance of the feed 106 with the impedance of the transceiver 115, thus reducing the SWR.

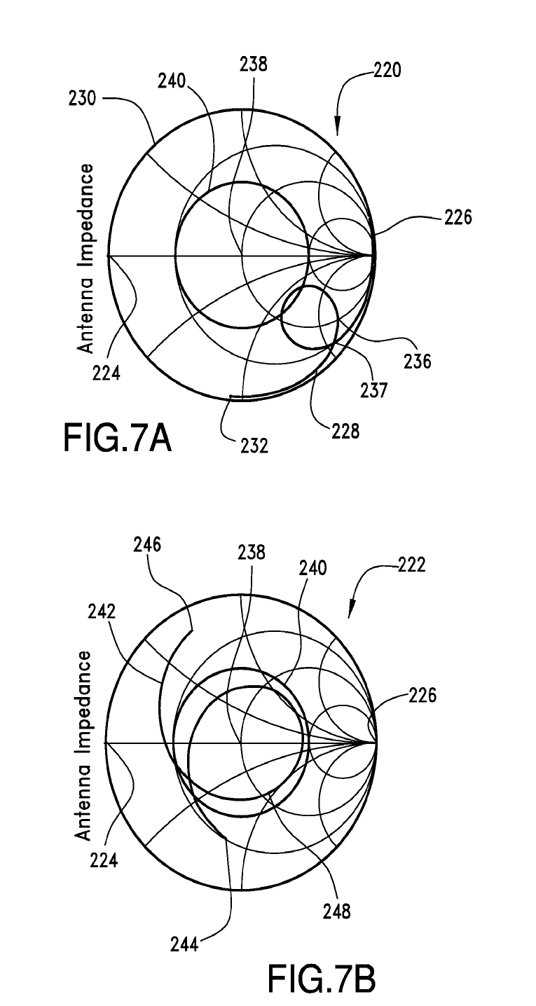

The Smith charts 220, 222 of FIGS. 7A and 7B provide plots of the impedance of a LISFA similar to those illustrated in FIGS. 5A and 5B. A low impedance reference point 224 is provided on the left of each Smith chart 220, 222 and a high impedance reference point 226 is provided on the right of the Smith charts 220, 222. The antenna impedance is plotted over a range of frequencies in each chart.

As with resonant element 14 of the HISFA 10, to be effective the resonant element 104, 142 of the LISFA 100, 140 should be in resonance at the desired frequency. An example of a desired frequency for resonance in a mobile telephone, for example, is 1850 MHz. As can be appreciated, the desired frequency will vary depending on the application. The antenna impedance plot 228 illustrated in FIG. 7A includes a first point 230 at a frequency of approximately 500 MHz and extends to a second point 232 which relates to a frequency of about 2500 MHz. At the first/low frequency point 230, the antenna impedance is relatively low and includes a positive imaginary component. As the frequency of the signal applied to the antenna is increased, the impedance of the resonant element 104 increases, until maximum impedance is reached proximate the reference point 226 at the far right side of the Smith chart. Increasing the frequency further, results in a decrease of the antenna's impedance and a negative imaginary component.

As discussed above with respect to FIGS. 3A and 3B, the element's resonant frequency is represented at the point where the plot 228 intersects with itself forming a curl within the plot 228. The plot 228 includes a curl 236 having a point of intersection 237. The frequencies along the curl 236 represent the range of frequencies within which the element 104, 142 of the LISFA 100, 142 will resonate. The curl 236 of the plot 228 provided in FIG. 7A begins at a frequency of approximately 1741 MHz and ends at a frequency of approximately 2048 MHz. In the example noted above, the desired resonant frequency is 1850 MHz and therefore easily falls within the range of resonant frequencies provided by the antenna 100. If the volume available for the element 104, 142 is too small for the element 100, 142 to resonate at the desired frequency, the resonant element 104, 142 can be forced into resonance at the desired frequency by applying a discrete inductor, Lᵣₑₛₒₙₐₙₜ 170, 192, between the ground plane 113 of the circuit board 102 and the resonant element 104, 142. Thus, the frequency at which the curl 236 or point of intersection occurs can be adjusted by varying the value of the discrete inductor Lᵣₑₛₒₙₐₙₜ.

As noted above, the location of the curl can be adjusted by increase the length of the corresponding slot, which will tend to move the location of the plot clockwise around the Smith chart. Furthermore, the size of the curl can be increased by increasing the ratio of capacitive coupling between the resonant element and the finger over the capacitive coupling across the slot. In addition to tuning the antenna to provide resonance at the desired frequency, the performance of the antenna 100, 140 can also optimized by matching the impedance of the feed 106 to the transceiver so that the curl is positioned in a circle 240, which represents a SWR of 3 in FIGS. 7A and 7B.

As noted above, the Smith chart 220 of FIG. 7A relates to a LISFA such as the LISFA 100 or 140 prior to impedance matching. The curl 236 of the plot of antenna impedance 228 is nearly entirely outside of the SWR of 3 circle 140, illustrating that almost no resonant frequencies are provided without significant reflections.

Impedance matching of the LISFAs 100, 140 of FIGS. 5A and 5B can be achieved by using the discrete matching circuit, L_{match} 172, 196. It should be noted, however, that the selection of the appropriate match circuit will depend on the location of the curl in Smith chart. The Smith chart 222 of FIG. 7B illustrates the potential benefits of being able to separately optimize curl size and location within the Smith chart. The plot 242 of antenna impedance includes a first point 244 corresponding with a frequency of approximately 1710 MHz and a second point 246 corresponding with a frequency of approximately 2170 MHz. As a result of impedance matching, the curl 248 of the plot 242 is positioned entirely within the SWR of 3 circle 240. The curl includes frequencies ranging from 1741 MHz to 2048 MHz. The impedance characteristic of the matched LISFA is very similar to that of a Chebychev match, which contributes to the improved impedance bandwidth.

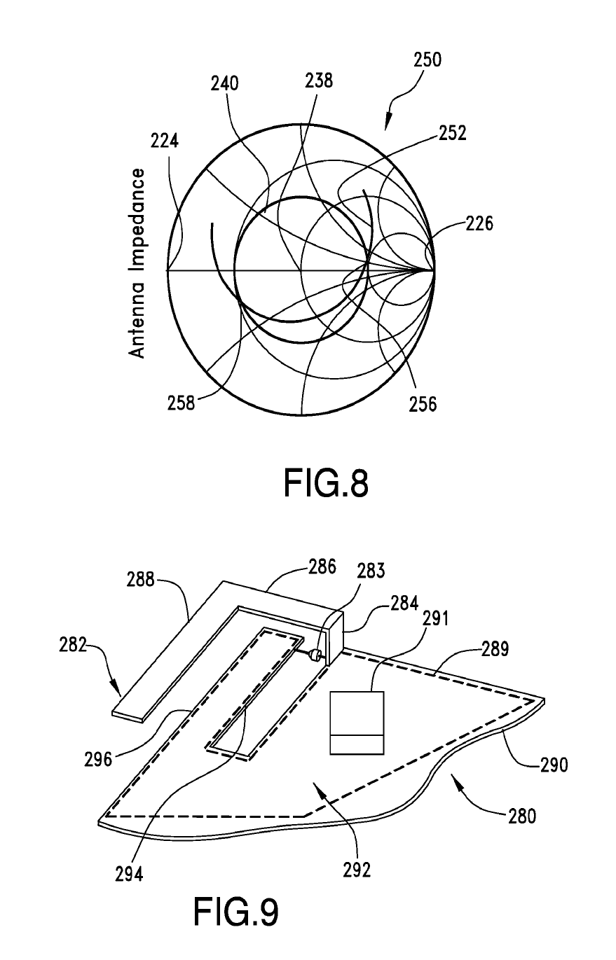

The Smith chart 250 of FIG. 8 provides a plot 252 of a standard direct feed antenna for comparison purposes. The dimensions of the standard resonant element of the antenna represented in FIG. 8 are similar to the dimensions of the resonant element 142 of the antenna 140. The slot 106 of the circuit board 102, however, has been replaced by a cutout having the same dimensions as the slot 106 and therefore, no slot is provided in the standard direct fed antenna. As illustrated in FIG. 8, the plot 252 includes only a portion of the curl representing resonant frequencies of the standard direct fed antenna. A first point of intersection 256 between the plot 252 and the SWR of 3 circle 240 corresponds with a frequency of approximately 1798 MHz and a second point of intersection 258 corresponds with a frequency of approximately 1972 MHz. Thus, the bandwidth of the antenna is from 1798 MHz to 1972 MHz.

As illustrated in Table 2 below, the impedance characteristic of the matched LISFA contributes to the improved bandwidth of the antenna. The improvement in bandwidth achieved by using a matched LISFA is compared to the bandwidth achieved with the standard direct fed antenna. The standard direct fed antenna has a bandwidth of 174 MHz whereas the same antenna indirectly fed and impedance matched achieves a bandwidth of 307 MHz, which is 76% improvement in frequency. Thus, compared to a standard direct-fed antenna, in an embodiment a LISFA can offer at least 50 MHz greater bandwidth and in an embodiment can offer more than 100 MHz improvement.

TABLE 2
Impedance bandwidth of Standard Direct Feed and
Low Impedance Slot Feed

| | | Bandwidth Frequencies at SWR = 3 | | |
|---|---|---|---|---|
| | Start | Stop | Bandwidth | Bandwidth |
| Standard Direct Feed | 1798 MHz | 1972 MHz | 174 MHz | 9.2% |
| Low Impedance | 1741 MHz | 2048 MHz | 307 MHz | 16.2% |
| Slot Feed | | | | |
| Improvement | | | 133 MHz | 76.1% |

Other possible configurations of the LISFA concept are shown in FIGS. 9-14. In each embodiment, the antenna functions comparable to the embodiments depicted in FIGS. 5A and 5B, thus the functionality will not be discussed in detail for purposes of brevity. In general, however, for a particular configuration it is possible to vary the Lᵣₑₛₒₙₐₙₜ value to force the resonant element to resonate at the desired frequency (e.g., to change the size of the curl so as to increase the potential bandwidth of the resonant element), to adjust the location of the plot in the Smith chart by changing the length of the slot, to adjust the size of the curl by adjusting the capacitive ratio and to vary the L_{match} to adjust the impedance of the antenna system so that it corresponds to the impedance of the transceiver (thus providing a desired SWR value). Naturally, as noted above, there is a limit to the bandwidth available for each antenna because at some point, further increasing the size of the curl would cause it to no longer fit within a desired SWR value, thus providing a diminish return,

FIG. 9 illustrates a LISFA antenna 280 including a circuit board 290 having a slot 294 therein, a resonant element 282, and a feed 283. The circuit board 290 includes a ground plane 289 and can include a transceiver 291 similar to that depicted in FIG. 1. The feed 283 would thus be in communication with the transceiver. The resonant element 282 is in electrical communication with the ground plane 289 of the circuit board 290 and includes a support portion 284, an extension portion 286, and a body 288. The support potion 284 of the resonant element 282 is supported by a circuit board 290 at a first end and the support portion 284 generally extends perpendicular to the circuit board 290. The support portion 284 is attached to a main portion 292 of the circuit board 290 proximate the slot 294. The extension portion 286 of the resonant element 282 extends from the support portion 284 and is generally positioned parallel to the circuit board 290. The extension portion 286 of the LISFA 280 extends across the slot 294 and across the edge portion 296 of the circuit board 290. The body portion 288 of the resonant element 282 extends from the extension portion 286 and is generally positioned beyond and parallel to the edge portion 296 of the circuit board 290. Thus, as can be appreciated, the body 288 is not directly over the ground plane 289 but is still capacitively thereto.

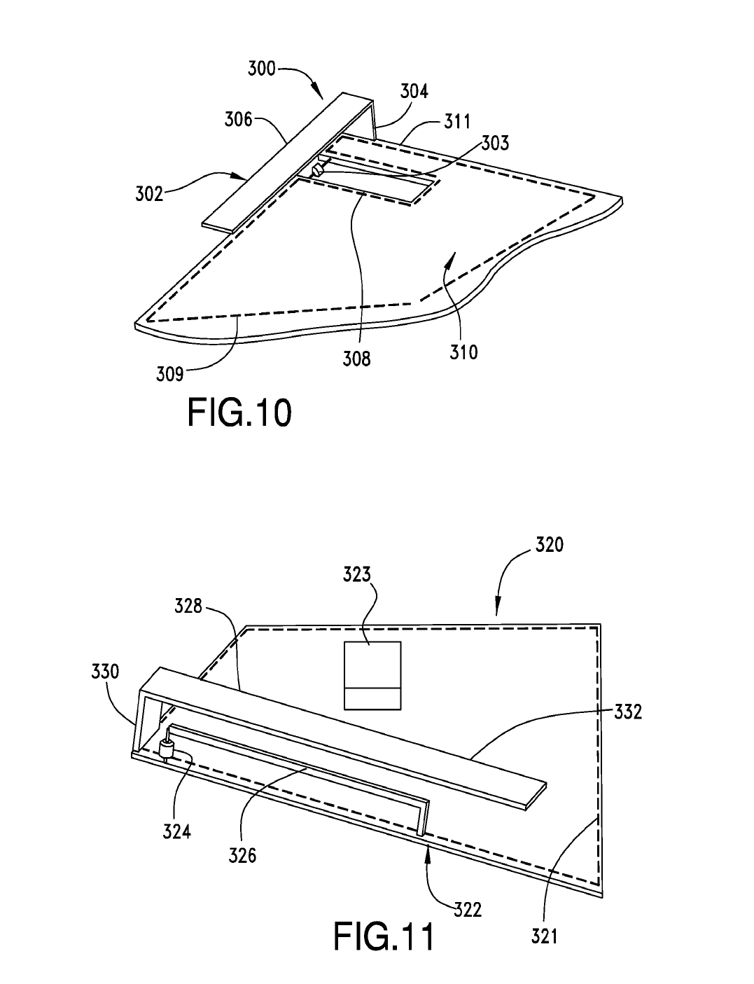

FIG. 10 illustrates a LISFA 300 that includes a resonant element 302 configured to be capacitively coupled to a ground plane 309 that is provided on a circuit board 310. The ground plane 309 (and as illustrated, the circuit board 310) has a slot 308 therein that forms a finger 311 (that also includes part of the ground plane 309) and a feed 303 is provided. The circuit board (as noted above) could support a transceiver configured to function with the antenna. The feed 303 is in communication with the transceiver and the resonant element 302 is capacitively coupled with the ground plane 309 of the circuit board 310. The resonant element 302 includes a support portion 304 and a body portion 306, wherein the body portion 306 of the element 302 is in a plane generally parallel to the circuit board 310. The body portion 306 of the resonant element 302 is generally positioned perpendicular to a slot 308 in the circuit board 310 and extends across the slot 308 in the circuit board 310. It should be noted that while an embodiment of a resonant element has been depicted with wither a perpendicular or a parallel orientation with respect to the slot, other orientation as also contemplated and for other resonant element shapes, a clear orientation may be not be appreciable.

FIG. 11 illustrates a LISFA 320 including a circuit board 322, a feed 324, a coupling element 326, and a resonant element 328 that includes a support portion 330 and a body portion 332. The circuit board 322 includes a ground plane 321 and a transceiver 323 (which can be configured as discussed above). The feed 324 includes a first/lower end and a second/upper end. The first/lower end of the feed 324 is in communication with the transceiver 323. The feed 324 extends out of the circuit board 322 to a coupling element 326 (which is shown as having an “L” shape) that extends generally parallel to the resonant element 328 and functions as the ground plane in the finger as described above (e.g., capacitively coupling to the resonant element 328) and uses the ground plane as the return path. Thus, the capacitive coupling between the coupling element 326 and the body 332 of the resonant element 328 is comparable to the capacitive coupling between the ground plane and the resonant element in FIG. 9, for example. Similarly, the capacitive coupling between the ground plane 321 and the coupling element 326 is comparable to the capacitive coupling across the slot in FIG. 9. The benefit of the embodiment in FIG. 11 is that coupling element 326 can be designed separately from the ground plane and, as it can be substantially separate from other components most of its length, potentially allows the system to be easier to tune. This also allows the resonant element 328 to be moved farther from the ground plane, which tends to improve the bandwidth of the resonant element.

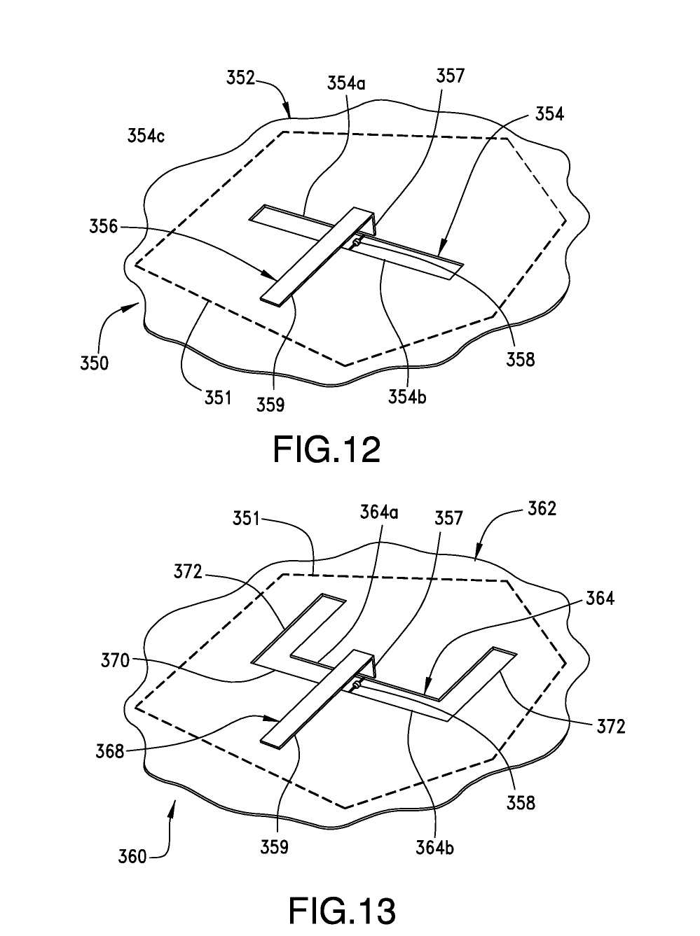

FIG. 12 illustrates a LISFA 350 with a resonating element 356 supported by a circuit board 352, a slot 354 positioned generally in the center of the circuit board 352, and a feed 358 extends across the slot 354 from edge 354a to edge 354b of ground plane 351. The circuit board 352 could also support a transceiver—not shown—as noted above. The resonant element 356 is in electrical communication with the ground plane 351 of the circuit board 353. The resonant element 356 includes a support portion 357 and a body portion 359 that capacitively couples to the ground plane 351. The support portion 357 is mounted on a first edge 354a of the slot 354 and supports the body portion that extends across the slot. Thus, as in the prior embodiment, the system performance can be adjusted as desired. As depicted, the first/lower end of the support portion 357 is generally centrally positioned along the length of the slot 354. The shortest distance around the around the slot 354 will affect the impedance of the feed 358 and thus a shorter slot can be used if the resonant element is centered. although centering is not required. It should be noted that the current path from the feed 358 back to the transceiver return (which in an embodiment can be positioned on a side of the slot corresponding to edge 354a) can pass around edge 354c but may not be directly align with the orientation of the resonant element 356. However, as depicted, the resonant element 356 is aligned with the feed 358 over part of the body portion 359.

FIG. 13 illustrates a LISFA 360 antenna system that includes a ground plane 351, a slot 364 with first side 364a and second side 364b, a feed 366, and a resonant element 368 and functions similarly to the antenna system depicted in FIG. 12 (a body 369 of the resonant element 368 couples to the ground plane 351). Rather than the generally linear slot 354 provided with the LISFA 350, the LISFA 360 includes a generally U-shaped slot 364. The slot 364 includes a central portion 370 having opposite first and second ends. A first extension 372 extends from the central portion 370 of the slot at the first end and a second extension 372 extends from the central portion 370 of the slot 364 at the second end. The first and second extensions 372 are generally perpendicular to the central portion 370. As noted above, increasing the length of the slot allows the location of the plot on the Smith chart to be adjusted and the U shape can be useful to minimize the area affected by the inclusion of a slot in the ground plane.

As can be appreciated from FIGS. 9-13, therefore, there are numerous possible configurations for indirectly feeding the resonant element. In certain configurations the resonant element will primarily couple to the ground plane (such as depicted in FIGS. 9, 10, 12 and 13) and in other configurations the resonant element will primarily couple to a coupler that is distinct from the ground plane (such as depicted in FIG. 11). The desired configuration will depend on the design of the circuit board, the available space and whether it is desirable to tune the performance of the system with a discrete coupler.

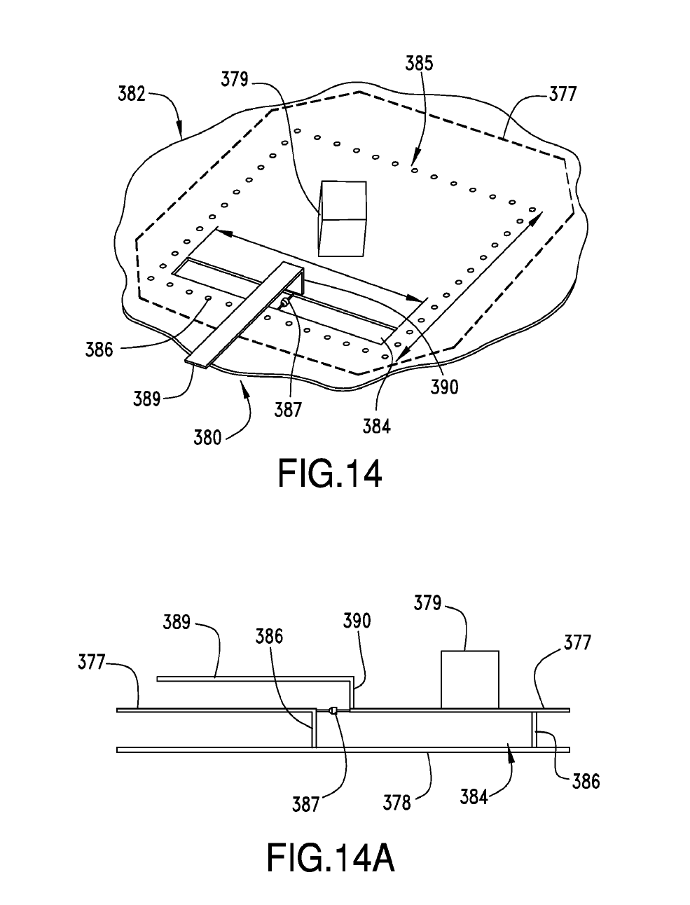

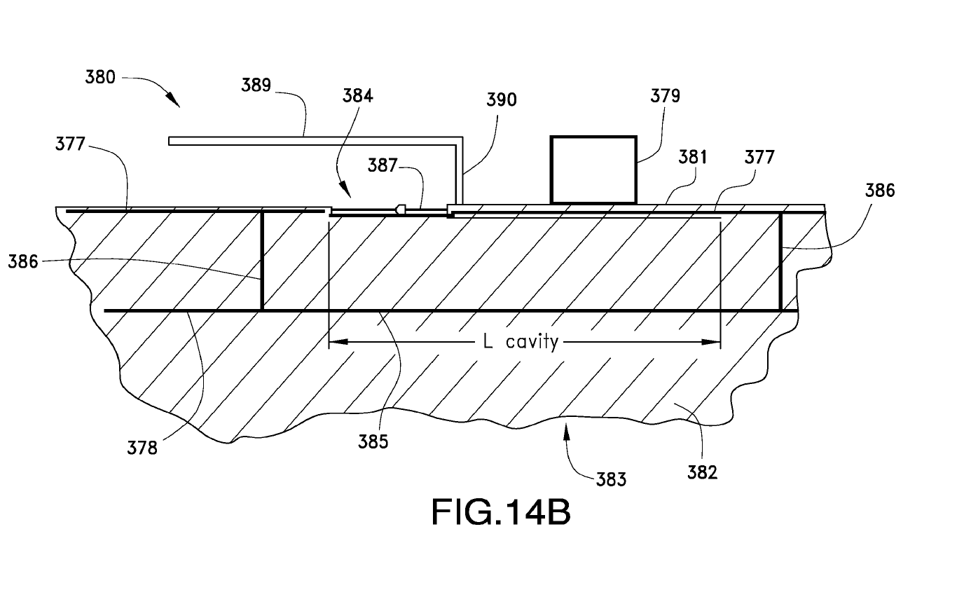

FIGS. 14, 14A and 14B illustrate another embodiment 380 of the LISFA. The embodiment 380 includes a circuit board 382, a slot 384 within the circuit board 382, a feed 387, a cavity 385, and a resonant element 389 supported by a ground arm 390. The circuit board 382 includes a ground plane 377 in communication with the resonant element 389 via the ground arm and a transceiver 379 in communication with the feed 387 (the ground plane, as noted above with respect to FIG. 1, extends over substantially the entire area). As in prior embodiments, the feed goes directly to the ground plane, which is capacitively coupled to the resonant element 389. Unlike the LISFAs illustrated in FIGS. 5A, 5B and 9-13 wherein the slots of each of the LISF penetrate all layers of the circuit board (because, for example, the slot is a slot in the circuit board), the slot 384 of the embodiment 380 can just penetrate a portion of the layers of the circuit board 382 and need only extend through the ground plane 377, which is coupled via one or more vias 386 to a second ground plane 378. As best illustrated in FIG. 14B, the slot 384 of the circuit board 382 is in communication with a cavity 385 in the circuit board 382. The cavity 385 is provided between an upper surface 381 of the circuit board 382 and a lower surface 383 of the circuit board 382. The cavity 385 (which, as shown, could be filled with a dielectric material such as normal circuit board material but does not have an electrical connection between ground plane 377 and the ground plane 378) has a length, L_{cavity} and a width W_{cavity}. An elongated aperture is provided through the upper surface 381 and the ground plane 377 proximate the perimeter of the cavity 384 to provide the slot 385 in communication with the cavity 385. The slot 384 has a length Lₛₗₒₜ and a width Wₛₗₒₜ. The feed 387 extends across the width of the slot 384. The length of the slot Lₛₗₒₜ is larger than the width of the slot Wₛₗₒₜ. When designing the cavity 385 and slot 384 it is beneficial that the electrical length of a signal extending around the cavity L_{cavity} is longer than the electrical length of going around the slot Lₛₗₒₜ. The shortest distance of the two (e.g., the length of the cavity 385 and the length of the slot 384) will determine the length of Lₛₗₒₜ.

One trend in antenna designs is to utilize a front end module (FEM) having two separate ports to the antenna, instead of a traditional single port. In a two port FEM, one port can be used for a first frequency range (e.g., a low frequency bands such as GSM850 and GSM900) and the other port is used for a second frequency range (e.g., a high frequency bands such as GSM 1800, GSM 1900 and UMTS Band I). In an embodiment, a dual antenna system could be provided by using two HISFA such as depicted in FIG. 1 (each one configured for a different frequency range) or two LISFA such as depicted in FIG. 5A (again with each configured for a different frequency range). In another embodiment, a HISFA such as is depicted in FIG. 1 can be used in combination with a LISFA such as is depicted in FIGS. 5A, 5B and 9-14A. Thus, a antenna system could provide a combination of both. As can be appreciated, such a design would be compatible with a two port FEM and allow for a compact and efficient antenna design. It is expected that such a design would also have very good isolation between the ports (potentially better than −20 dB isolation between 800 MHz and 2.4 GHz). It should be noted that any desirable configuration of LISFAs and/or HISFAs could be provided but for purposes of brevity, illustrations showing the various embodiments in combination are omitted, it being understood that the particular configuration of LISFA and HISFA used would depend on the application.

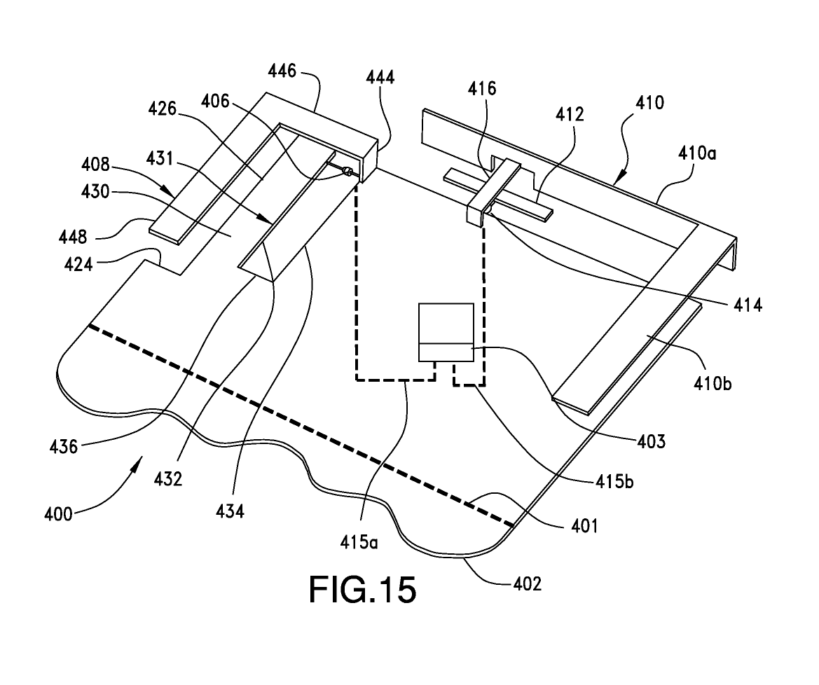

While using a single LISFA in combination with HISFA can provide an acceptable solution for certain applications, it has been determined that even further improvement is possible. For example, an antenna system 400 as depicted in FIG. 15 with even greater high band performance can be obtained by combining a HISFA and LISFA in a manner that allows the LISFA to have even greater bandwidth.

As depicted, the antenna system 400 is supported by a circuit board 402, which also supports a two-port transceiver 403. One port is coupled via transmission line 415a to feed 406 and drives the LISFA and the other port is coupled via transmission line 415b to feed 414, which drives the HISFA. The LISFA comprises a resonant element 408 capacitively coupled to a ground plane 401 which is depicted as extending fully across the circuit board 402 and provides a slot 431 that helps define a finger 430 and functions in a manner similar to the embodiment depicted in FIG. 9 (with the cutout in the ground plane defined by edge 424, 426 being used to help improve bandwidth of the LISFA). The ground plane 401 in the finger 430 capacitively couples to body 448, which is supported by support 444 and arm 446. Thus, the LISFA functions as discussed above and distance between edges 432, 434 can be adjusted to vary the capacitive coupling therebetween. Furthermore, the length of the slot 431 (which is defined by edge 436) can vary so as to adjust a location of the corresponding plot on a Smith chart. The HISFA similarly functions as discussed above with respect to FIG. 1 and comprises a resonant element 410, which is capacitively coupled to coupler element 412 and is also electrically coupled to the ground plane 401 via support 416. However, the resonant element 410, which includes first resonating element 410a and a second resonating element 410b, which together provides a total length used to provide the desired frequency response of the resonant element 410, is also configured so that the length is approximately half a wave length at the center of the high frequency band (1950 MHz) supported by the LISFA and therefore can function as a parasitic resonating element.

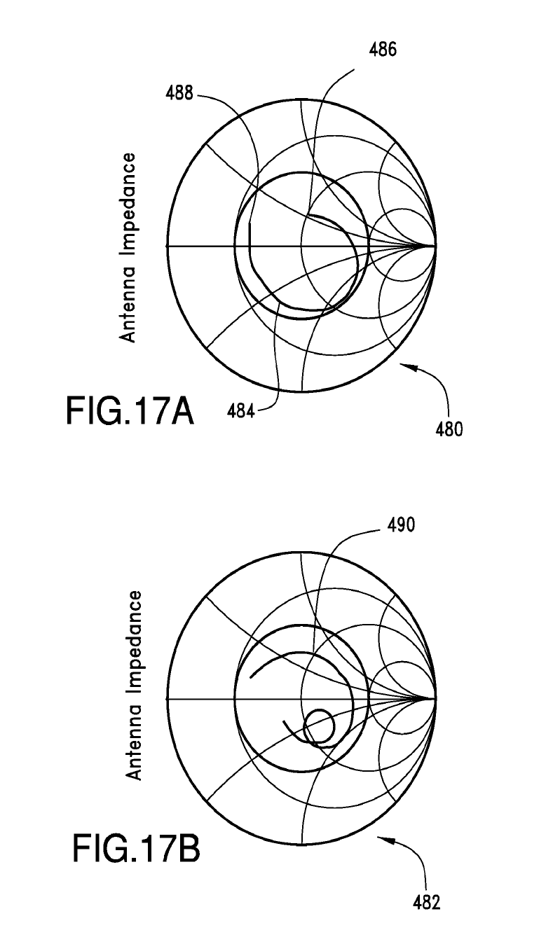

In FIG. 17B, for example, a second curl can be seen and this is provided by the resonant element 410 acting as a parasitic resonating element for the high band frequency. As can be appreciated, having a second curl allows for the possibility of greater frequency response without exceeding a desired SWR value. In order for the parasitic element to provide a desirable effect, the length of the resonating element 410 (a portion of which is aligned with the LISFA body) is set so that it is approximately one-half the wave length of the desired resonant frequency of the LISFA. In effect, the second resonating element 410b acts as an amplifier of the frequency of interest, thus helping to improve the bandwidth of the high-band antenna.

In operation, therefore, the transceiver 403 causes a first driving frequency (e.g., a high-band frequency) to be applied to the feed 406 via the first port of the transceiver 403 (e.g., via the first port 456 of a FEM) and this causes the resonating element 408 to resonate. Because of the length of the resonation element 410, the Smith chart has a double curl (which can still be increased in size by adjusting the capacitive ratios as discussed above) and thus resonates at a broader range of frequencies and offers an increased bandwidth. Meanwhile, a second driving frequency is provided to the feed 414 from a second port of the transceiver 403, which causes the resonating element 410 to function in a manner similar to that discussed above.

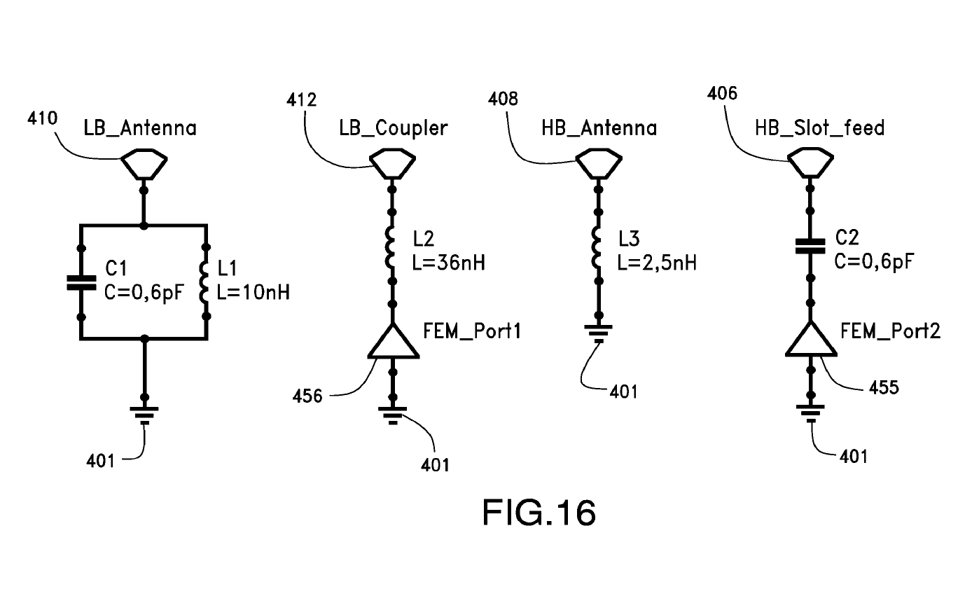

As shown in FIG. 16, which a representation of the inputs provided and received by the transceiver, the low band coupler 412 is fed by FEM port-1 456 and the impedance match can be adjusted by inductor L2 (which can have a value of 36 nH) so the SWR is in a desirable range for the frequencies of interest. To adjust the frequency response of the low band antenna, resonant inductance can be adjusted by placing the parallel circuit of C1 and L1 in between the antenna and a ground plane 401. It has been determined for that certain embodiments, frequency response can be adjusted by L1 and the value of C1 can be adjusted to create a parallel resonator (with L1) at the center of the high band (1950 MHz) to isolate the resultant parasitic element from ground at this frequency range. The high band antenna has a feed 406 that is driven by port 2 and a capacitor C2 is placed in series so as to provide the desired impendence match. The high band antenna has an inductor placed between it and the ground plane to insure the frequency response is centered at the frequency of interest. The actual frequency response of the antennas can be as shown above, except that the parasitic element will tend to increase the range of frequencies that resonate the resonating element of the LISFA (thus increasing the bandwidth). As can be appreciated, the various changes to adjust the location of the plot, as well as the size and location of the curl, on the Smith chart can be adjusted as discussed above.

In an embodiment, for example, the antenna system 400 can be tuned for operation at high frequencies, such as for example those ranging from 1710 MHz to 2170 MHz and have a center frequency therefore at approximately 1950 MHz. Thus, in order for the parasitic resonance element 410 to stimulate the resonant element 408, the length of the parasitic element 410, which is shown aligned with the body 448, may be configured so that it is approximately one-half the wave length of a 1950 MHz signal.

The Smith charts 480 and 482 of FIGS. 17A and 17B provide plots of the impedance of the antenna system 400 illustrated in FIG. 15 over a two ranges of frequencies wherein the impedance of the LISFA 408 and the impedance of the HISFA 410 have been matched. As discussed above, the resonant frequencies of the resonant element 408 are represented by the frequencies along the curl. FIG. 17A provides a plot 484 of the impedance of the HISFA 405 in the low frequency band. The plot 484 includes a portion of a curl that includes a first point 486 which relates to a frequency of 824 MHZ and a second point 488 which relates to a frequency of 960 MHZ. The plot 490 of FIG. 17B includes two curls, the second curl generated by the parasitic element and the impedance plot represents resonant frequencies of the resonant element 408 ranging from 1710 MHz to 2170 MHz. As can be appreciated from FIG. 17A and 17B, therefore, a system with a HISFA and a LISFA configured as depicted can fulfills penta-band requirements using a very small volume, as compared to traditional antenna designs.

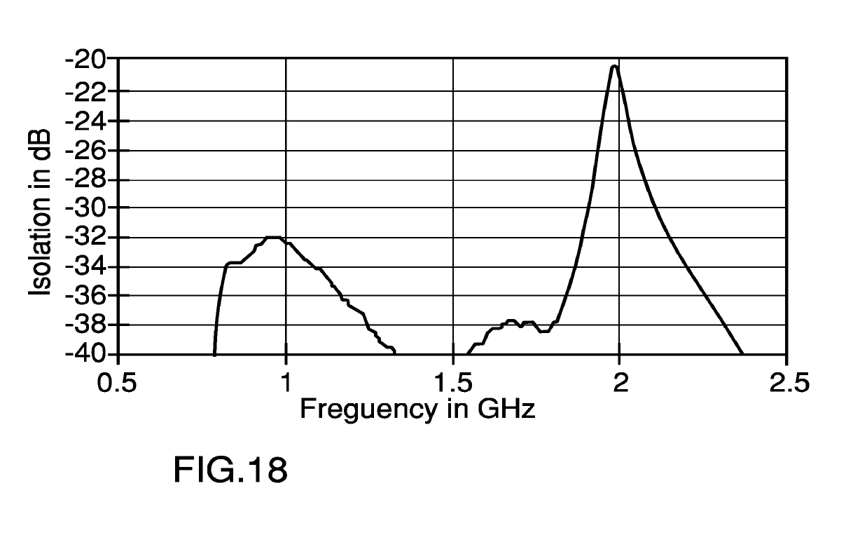

Because the antenna system 400 utilizes two independent feeding connections 406, 414, it is beneficial that sufficient isolation be provided between the feed 406 and the feed 414. The isolation for the antenna system 400 is illustrated in FIG. 18. As illustrated, isolation of greater than -20 dB is achieved over the entire frequency range. In part, this is because the indirect feed to the low band antenna is provided through a coupler, which helps provide good isolation.

While preferred embodiments are shown and described, it is envisioned that those skilled in the art may devise various modifications of the disclosure without departing from the spirit and scope of the appended claims.

The invention claimed is:

1. An antenna system, comprising:
a ground plane with an edge;
a resonating element with a body extending along the edge and a support arm, the support arm electrically coupling the body to the ground plane;
a feed configured to receive a signal from transmitter; and
a coupler positioned along the edge and electrically coupled to the feed and electrically isolated from the resonating element, the coupler configured to capacitively couple to the body of the resonating element and to capacitively couple to the ground plane.

2. The antenna system of claim 1, wherein a plot of impedance of the antenna system on a Smith chart includes a curl representing a resonant frequency of the antenna system in a first location and the coupler extends along the edge of the ground plane a first distance, wherein changing the first distance to a larger second distance causes a location of a plot of the antenna impedance on a Smith chart to rotate in a clockwise direction to a second location.

3. The antenna system of claim 2, wherein increasing a ratio of capacitive coupling between the coupler and the resonant element over capacitive coupling between the coupler and the ground plane increases the curl from a first size to a second size.

4. The antenna system of claim 3, further including a predetermined matching network electrically coupled to the feed, the predetermined matching network configured to shift the location of a curl on the Smith chart so that a substantial portion of the curl is position within a standing wave ratio (SWR) circle of 3.

5. The antenna system of claim 4, further comprising a discrete inductor positioned in between the body and the ground plane.

6. The antenna system of claim 4, wherein the impedance matching network is one of an inductor or a capacitor in series with the feed.

7. An antenna system, comprising:
a ground plane in a circuit board with a slot having a first length, the slot having a first and second opposing edge, the slot configured to provide an capacitive coupling across the slot;
a feed extending from the first edge to the second edge and configured to receive a signal from a transceiver; and
a resonating element with a support arm and a body, the support arm electrically coupled to the ground plane and the body positioned so as to capacitively couple to the ground plane on a side of the slot aligned with the second edge, wherein the slot is configured so that, in operation, a signal current path from the feed back to the transceiver moves along the second edge in a first direction and along the second edge in a second direction.

8. The antenna system of claim 7, wherein the ground plane is part of a circuit board and the slot extends through the circuit board, wherein the slot defines a first portion of the circuit board on one side of the slot and a second portion on the second side of the slot.

9. The antenna system of claim 8, wherein the resonant element is supported on the first portion of the circuit board and the resonant element extends across the slot.

10. The antenna system of claim 8, wherein the first portion is a main portion and the second portion is a finger portion and the resonant element is attached to the finger portion and the resonant element extends over the finger portion of the ground plane.

11. The antenna system of claim 7, wherein the slot is generally U-shaped.

12. The antenna system of claim 7, further comprising a discrete inductor in series between with the ground plane and the body of the resonant element.

13. The antenna system of claim 7, further comprising a matching network in electrical communication with the feed, the matching network configured, in operation, to match the impendence of the feed with a corresponding transceiver so as to provide a standing waver ratio (SWR) of less 3 over a range of frequencies.

14. The antenna system of claim 13, wherein the matching network is provided by one of an inductor or capacitor in series with the feed.

15. The antenna system of claim 8, wherein the edge portion of the circuit board includes a notch, the resonant element is attached to the main portion of the circuit board and a portion of the resonant element is aligned with the cutback.

16. The antenna system of claim 7, wherein the resonant element is a first resonant element, the antenna system further comprising:
a coupler spaced from the ground plane;
a second resonant element spaced from the circuit board and the coupler and having a first and second body portion, the second resonant element electrically coupled to the ground plane via a support, wherein the coupler is configured to capacitively couple to the ground plane and to the resonant element, and wherein the resonant element is configured to be about one half (½) a wavelength of a desired resonant frequency associated with the first resonant element; and
a second feed electrically coupled to the coupler and configured to receive a signal from the transceiver.

17. The antenna system of claim 16, wherein the second resonating element is generally L-shaped.

18. The antenna system of claim 16, wherein the first resonant element is configured to have a frequency response with a standing waver ratio (SWR) of less than 3 over at least 300 MHz and the second resonant element is configured to have a SWR of less than 3 over at least 100 MHz.

19. The antenna system of claim 18, wherein the first resonant element is configured to have a frequency response centered between 1710 MHz and 2170 MHz.

20. The antenna system of claim 19, wherein the second resonant element is configured to have a frequency response centered between 820 MHZ and 960 MHz.
